(19) United States
(12) Patent Application Publication
(10) Pub. No.: US 2026/0326720 A1
(43) Pub. Date: Oct. 22, 2026

(54) CONNECTOR FOR A WIPER SYSTEM

(71) Applicant: VALEO SYSTEMES D'ESSUYAGE, La Verriere (FR)

(72) Inventors: Gérald CAILLOT, La Verriere (FR); Jean-Michel JARASSON, La Verriere (FR); Vincent IZABEL, La Verriere (FR); Djamel CHARAFA, La Verriere (FR)

(73) Assignee: VALEO SYSTEMES D'ESSUYAGE, La Verriere (FR)

(21) Appl. No.: 19/106,667

(22) PCT Filed: Aug. 25, 2023
(86) PCT No.: PCT/EP2023/073426

§ 371 Date: Feb. 26, 2025

(30) Foreign Application Priority Data
Aug. 31, 2022 (FR) FR2208731

(51) Int. Cl. B60S 1/52; B60S 1/40

(52) U.S. Cl. CPC B60S 1/522; B60S 1/40

(57) ABSTRACT

The invention relates to a connector for connecting a wiper blade of a vehicle wiper system to a drive arm of the wiper system. The connector includes a circuit for conveying cleaning fluid defined within the connector and extending between a fluid inlet and at least one fluid outlet, the circuit for conveying cleaning fluid includes a distribution duct extending longitudinally from one longitudinal end of the connector to the other and a conveying duct leading into the distribution duct forming a distribution node. The distribution node includes an opening sealed by a cover, the cover including at least one spray orifice.

### TECHNICAL FIELD

The present invention relates to the field of wiper systems for glazed surfaces, notably for a windshield or rear window, of a vehicle. More particularly, the present invention relates to a wiper blade with which such wiper systems are fitted and which is configured to spray a cleaning fluid.

### BACKGROUND OF THE INVENTION

Commonly, a vehicle comprises various glazed surfaces, notably at the front or the rear of the vehicle, which allow a driver to see the outside environment and more particularly the road scene. To this end, the glazed surface must be transparent and optically neutral so that the driver can see the environment around the vehicle properly.

Each glazed surface of the vehicle that is between the vehicle interior and the outside environment is exposed to weather conditions, such as rain, but also to certain particles or dirt which can at least partially obstruct or impede the driver's view of the outside environment.

To expel these various elements, the vehicle comprises a wiper system capable of wiping and thus expelling the water or the various elements likely to be present on the glazed surface of the vehicle from said glazed surface.

It is known that such wiper systems comprise at least one drive arm and one wiper blade. The drive arm is secured to the vehicle by one of its ends and bears the wiper blade via its opposite end, and it is notably capable of performing a back-and-forth movement allowing the wiper blade to wipe a large portion of the glazed surface.

To this end, the wiper blade comprises a blade rubber intended to be pressed against the glazed surface, a rigid blade-rubber support and a connector intended to connect the blade-rubber support to the drive arm of the wiper system. The wiper blade furthermore comprises aerodynamic deflection elements mounted on the rigid blade-rubber support and placed on either side of the connector.

It is known practice to fit the vehicle with a system for spraying a cleaning fluid toward the glazed surface to facilitate the cleaning of the particles and/or dirt present on the glazed surface by means of the wiper blade. This spraying system may comprise spray nozzles installed on the vehicle hood and/or a spraying system built directly into the drive arm and/or the wiper blade.

In the case of a spraying system integrated in a wiper blade, a spray line is generally formed within each of the aerodynamic deflection elements so as to communicate with a plurality of holes which are provided in the corresponding aerodynamic deflection element and through which the fluid is sprayed toward the glazed surface. Each aerodynamic deflection element is connected, at one longitudinal end, to the connector. It is known practice to thus have a connector which comprises a conveying circuit via which the fluid is able to flow from a fluid inlet of the connector to fluid outlets of the connector so as to join the spray lines formed in the deflection elements.

It is thus known practice to have a conveying circuit within the connector which comprises a conveying duct connected to the fluid inlet and a distribution duct connected to the fluid outlet, with the conveying duct leading into the distribution duct while forming a distribution node. It is easy to produce the distribution duct, which extends substantially longitudinally within the connector, from one fluid outlet to the other by drilling. The production of the conveying duct, at the core of the connector and possibly extending in a series of several directions, is more complicated and can involve a bore which leads out of the connector at the distribution node.

Such a built-in system is particularly effective in that it makes it possible to target the spraying of fluid onto the glazed surface just before the blade rubber scrapes the glazed surface. The orifices are provided at regular intervals in each aerodynamic deflection element such that the glazed surface is wetted uniformly. However, the distribution of the orifices on the deflection elements as known in the prior art does not make it possible to spray the fluid uniformly over the glazed surface since at least the connector is not fitted with spraying means. The result of this distribution is that there are zones of the glazed surface that do not receive any fluid, or at the very least that a zone of the glazed surface next to a zone of the blade that includes the connector receives a smaller amount of sprayed fluid than the neighboring zones next to zones of the blade that include deflection elements. At these zones of the glazed surface which receive little or no fluid, the wiper system is unable to effectively expel the particles and/or dirt.

### SUMMARY OF THE INVENTION

The present invention proposes overcoming the drawbacks of the prior art, and notably improving the distribution of fluid over the glazed surface of the vehicle, by means of a connector for connecting a wiper blade of a wiper system of a vehicle to a drive arm of the wiper system, the connector comprising a cleaning-fluid conveying circuit defined within the connector and extending between a fluid inlet, configured to interact with a cleaning-fluid supply hose, and at least one fluid outlet, configured to communicate with a cleaning-fluid spray channel within the wiper blade, the cleaning-fluid conveying circuit comprising at least one distribution duct extending longitudinally from one longitudinal end of the connector to the other and a conveying duct leading into the distribution duct while forming a distribution node, the at least one fluid outlet longitudinally extending said distribution duct, characterized in that the distribution node comprises an opening which is on an outer face of the connector and is shut off by a cover, the cover comprising at least one spray orifice.

The wiper blade notably has a rigid blade-rubber support, which is secured to the connector and on which are mounted on one side a blade rubber intended to be pressed against the glazed surface to be cleaned and on the other side an aerodynamic deflection element configured to deflect a flow of air and to contribute to pressing the blade rubber against the glazed surface.

The connector has formed within it a cleaning-fluid conveying circuit which comprises at least one conveying duct and a distribution duct. It should be understood that the conveying circuit may comprise more conveying ducts as long as the connector comprises a distribution node according to the invention which has a conveying duct which leads into the distribution duct. This distribution duct extends longitudinally along the connector and is bordered at each of its longitudinal ends by a connection element which is configured to interact with a deflection element of the blade and is in the form of a cannula.

The conveying duct makes it possible for the cleaning fluid to flow to the distribution duct such that the cleaning fluid entering the connector reaches the distribution duct by having flowed through the conveying duct beforehand.

Producing this conveying duct by a drilling operation involves an opening being made on the outside of the connector in the distribution node where the conveying duct and the distribution duct meet, this opening being formed in a wall of the connector in the extension of the conveying duct. This opening is shut off by the cover such that the cleaning fluid which passes through the distribution node can largely be directed into the distribution duct and then into the spray lines formed within aerodynamic deflection elements of the blade that are connected to the connector at the end of the distribution duct. According to the invention, at least one spray orifice is advantageously drilled in the cover. It will be understood that this at least one spray orifice is a through-orifice, i.e. it emerges from the cover into the distribution duct via one end and out of the connector via an opposite end. In this way, a small portion of the cleaning fluid entering the distribution node can be sprayed out of the connector and directed onto the glazed surface facing the connector. A contribution is thus made to more evenly distributing the spraying of cleaning fluid onto the glazed surface, since cleaning fluid is sprayed at the connector, between the holes moreover provided in the lines integrated in the aerodynamic deflection elements on either side of this connector.

It is notable that the connector according to the invention, and more particularly the presence of this at least one spray orifice provided specifically in a cover dedicated to closing an opening which is produced, by a drilling operation, in the extension of a conveying duct, makes it possible to implement a more uniform spraying of cleaning fluid over the entire longitudinal dimension of the wiper blade fitted with this connector, by advantageously using the cover which is moreover necessary for channeling the flow of the cleaning fluid within the connector. The result is an integration of function at the cover, since it is not only configured to contribute to defining the distribution duct but also configured to make it possible to spray cleaning fluid onto the glazed surface.

The arrangement of at least one spray orifice provided in the cover has the advantage of being able to be realized before the cover is assembled with the connector, i.e. before placing the cover in the opening. It is therefore possible to preform covers with a spray orifice, for example by an additive manufacturing operation, or by a laser welding operation which is easier to implement when the cover is not mounted on the connector, whereupon the covers having a spray orifice are assembled with connectors comprising a distribution node, and more specifically an opening leading out of the connector.

According to one feature of the invention, the cover is made of the same material as that used to produce the connector. “Same material” should also be understood to mean materials prepared on the same basis with different grades.

According to one feature of the invention, the at least one spray orifice is advantageously provided in the cover in a direction which, when the cover is assembled with the connector, is substantially parallel to a main axis of elongation of the conveying duct. Furthermore, the axis of the spray orifice is configured such that the cleaning fluid is sprayed from the spray orifice toward the glazed surface of the vehicle.

According to one feature of the invention, the at least one spray orifice has a diameter which ranges between 0.05 mm and 0.6 mm. With preference, the diameter of the at least one spray orifice ranges between 0.05 mm and 0.3 mm.

According to one feature of the invention, a single spray orifice centered on the outer surface of the cover is drilled in the cover.

According to one feature of the invention, the connector comprises at least one distribution zone which is provided at least partially along the distribution duct and in which spray holes are formed, the cover being disposed in the longitudinal extension of this at least one distribution zone.

Irrespective of the number and arrangement of the distribution zones, the cover and the spray orifice formed in the cover form, together with the one or more distribution zones, an overall zone of uniform distribution which extends from one longitudinal end of the connector to the other. According to one feature of the invention, the cover may take a centered position with respect to the longitudinal dimension of the connector and be placed between two distribution zones of equivalent longitudinal dimensions. According to an alternative feature of the invention, the cover may be offset and close to a longitudinal end of the connector and communicate directly with a cannula forming the longitudinal end of the connector, such that a single distribution zone extends on the other side of the cover.

It should be noted that the cover is distinct from the at least one distribution zone as defined, i.e. a zone provided at least partially along the duct and having at least one spray hole, and that this cover is configured to form, together with the one or more distribution zones to the side of which it is placed, a uniform overall distribution zone which makes it possible to spray cleaning fluid evenly along the connector.

According to one feature of the invention, the cover is placed so as to lie flush with the outer face of the connector in the at least one distribution zone.

According to one feature of the invention, the cover has a thickness equal to the thickness of the at least one distribution zone.

According to one feature of the invention, two distribution zones are formed one on each side of the cover within which the at least one spray orifice is provided, spray holes being formed in each of the distribution zones.

According to one feature of the invention, the outer face of the at least one distribution zone is formed by a flattened portion which extends in a plane substantially perpendicular to a direction parallel to a spray axis of the spray orifice.

It will be understood that the flattened portion extends in a plane that makes it possible, advantageously, to drill cleaning-fluid spray holes on either side of the cover, in addition to the spray orifice, along a spray axis perpendicular to said plane in which the flattened portion extends. It should be noted that the axis of the spray holes is substantially parallel to the axis of the spray orifice and that the flattened portion makes it possible to ensure a greater reproducibility of the spray holes than if the drilling was done on a curved surface.

According to one feature of the invention, the cover is placed so as to lie flush with the flattened portion of the at least one distribution zone.

According to one feature of the invention, at least two spray holes communicating with the distribution duct are placed on each side of a transverse midplane of the connector, which is perpendicular to the longitudinal direction of the distribution duct. This transverse midplane divides the connector into two parts of the same longitudinal dimension. This transverse midplane can divide the cover into two equal parts, with the spray orifice being provided on this transverse midplane.

According to one feature of the invention, spraying means are provided on the connector at regular intervals. The spraying means are the elements of the connector that allow the cleaning fluid to be sprayed toward the glazed surface of the motor vehicle. These spraying means comprise the spray holes provided in the distribution zone, as and when necessary in the flattened portion, and the spray orifice provided on the cover. As mentioned, the distribution duct is defined within the distribution zone which faces the glazed surface to be cleaned, with a large number of spraying means being formed in the distribution zone so as to make it possible to spray cleaning fluid at regular intervals at the connector, just as can be the case at the rest of the wiper blade. It will be understood that the distance between two adjacent spraying means on the distribution zone of the connector is a fixed distance that depends on the diameter of the spraying means. More particularly, the distribution zone comprises at least four spray holes, with two spray holes placed on either side of the transverse midplane of the connector which longitudinally divides the connector into two parts of substantially equal longitudinal dimensions, and as and when necessary placed on either side of the cover and of the at least one spray orifice which are provided at this transverse midplane.

According to one feature of the invention, the spraying means extend respectively along a spray axis, this spray axis of a spraying means intersecting the distribution duct. It will be understood that a cleaning fluid flowing in the distribution duct can be sprayed out of the distribution duct through the spraying means.

According to another feature of the invention, the spray holes are placed in a symmetrical distribution on either side of the transverse midplane of the connector. This symmetrical distribution of the spray holes makes it possible to spray the cleaning fluid toward the glazed surface uniformly all along the distribution zone of the connector.

According to one feature of the invention, the at least one distribution zone comprises at least four spray holes on each side of the transverse midplane of the connector and the spray orifice formed in the cover which is provided on this transverse midplane.

According to one feature of the invention, the spraying means are placed so as to form a single longitudinal row.

According to an alternative feature of the invention, the spraying means are staggered, in at least two distinct longitudinal rows. It is thus possible to optimize the direction in which the cleaning fluid is sprayed over several distinct zones of the glazed surface to be cleaned.

According to another feature of the invention, each spraying means has a diameter about the spray axis which ranges between 0.05 mm and 0.6 mm, preferably between 0.05 mm and 0.3 mm.

According to one feature of the invention, each spraying means has a diameter equal to the mean diameter of the neighboring spraying means.

According to another feature of the invention, each spraying means formed in the at least one distribution zone and the cover is spaced apart from a neighboring spraying means by a distance that ranges between 0.2 mm and 20 mm. With preference, the distance between two neighboring spraying means ranges between 0.28 mm and 13.70 mm.

According to one feature of the invention, the distance is a function of the diameter of each spraying means, with it being possible for the diameter of each spraying means to vary from 0.05 mm to 0.3 mm, the distance consequently varying from 0.28 mm to 13.70 mm. The distance between two spraying means is measured from a spray axis of a first one of the two spraying means to the other spray axis. The distance between two neighboring spraying means increases as the diameter of the spraying means increases.

According to one feature of the invention, the spraying means are obtained by means of laser drilling. A drilling operation by a laser source can advantageously make it possible to form orifices of small diameters with high precision. The implementation of such a drilling operation in a distribution zone which has a flattened portion and a constant thickness makes it possible to form spraying means of small dimensions, repeatably from one spraying means to the next.

According to one feature of the invention, the at least one distribution zone has a constant thickness. More particularly, the at least one distribution zone has a constant thickness over a longitudinal dimension from one spraying means to a neighboring spraying means, the thickness of the distribution zone being measured in a direction parallel to the spray axis of a spraying means.

According to one feature of the invention, the at least one distribution zone of constant thickness extends from a longitudinal end of the connector to the cover.

The invention also relates to a wiper blade of a wiper system of a vehicle comprising at least one connector according to one of the aforementioned features for connecting the wiper blade to a drive arm of the wiper system.

According to one feature of the invention, the wiper blade has holes which are formed on deflection elements or a blade-rubber support and via which cleaning fluid can be sprayed onto a glazed surface to be cleaned, the spraying means being placed on the connector such that a distance between two neighboring spraying means is substantially equal to a mean value of the distances between two neighboring holes of the wiper blade.

### BRIEF DESCRIPTION OF DRAWINGS

Other features, details and advantages of the invention will become more clearly apparent on reading the description below and on studying several exemplary embodiments given by way of non-limiting indication with reference to the appended schematic drawings, in which:

FIG. 1 illustrates a wiper system comprising a drive arm and a wiper blade according to the invention, connected to the arm notably by a connector and extending mainly in a longitudinal direction;

FIG. 2 schematically illustrates a perspective view of a connector of a wiper blade according to that in FIG. 1, the connector comprising a cover according to the invention and two distribution zones, with eight cleaning-fluid spray holes placed on either side of a spray orifice formed in the cover;

FIG. 3 schematically illustrates a view, in partial section, of the connector shown in FIG. 2;

FIG. 4 schematically illustrates a sectional view of the connector through the sectional plane B-B illustrated in FIG. 3, showing the spray orifice provided, according to the invention, through the cover, and the thickness of the connector at the cover;

FIG. 5 schematically illustrates a sectional view of the connector through the sectional plane A-A illustrated in FIG. 3, showing the thickness of at least one distribution zone, which is equal to that of the thickness of the connector at the cover shown in FIG. 4;

FIG. 6 schematically illustrates a perspective view of a first embodiment variant of the connector in FIG. 2, the connector comprising two distribution zones, with eight cleaning-fluid spray holes placed on either side of a spray orifice formed in the cover, the spraying means being arranged so as to form two distinct parallel rows; and

FIG. 7 schematically illustrates a sectional view similar to that of FIG. 5 of a second embodiment variant of the connector in FIG. 2, the connector comprising at least one distribution zone of continuous thickness where the outer face of the at least one distribution zone is not realized by a flattened portion but has a rounded shape.

The features, variants and various embodiments of the invention may be combined with one another, in various combinations, as long as they are not mutually incompatible or mutually exclusive. It will be possible, in particular, to conceive of variants of the invention that comprise only a selection of features described below, in isolation from the other features described, if this selection of features is sufficient to confer a technical advantage and/or to distinguish the invention from the prior art.

### DETAILED DESCRIPTION OF THE INVENTION

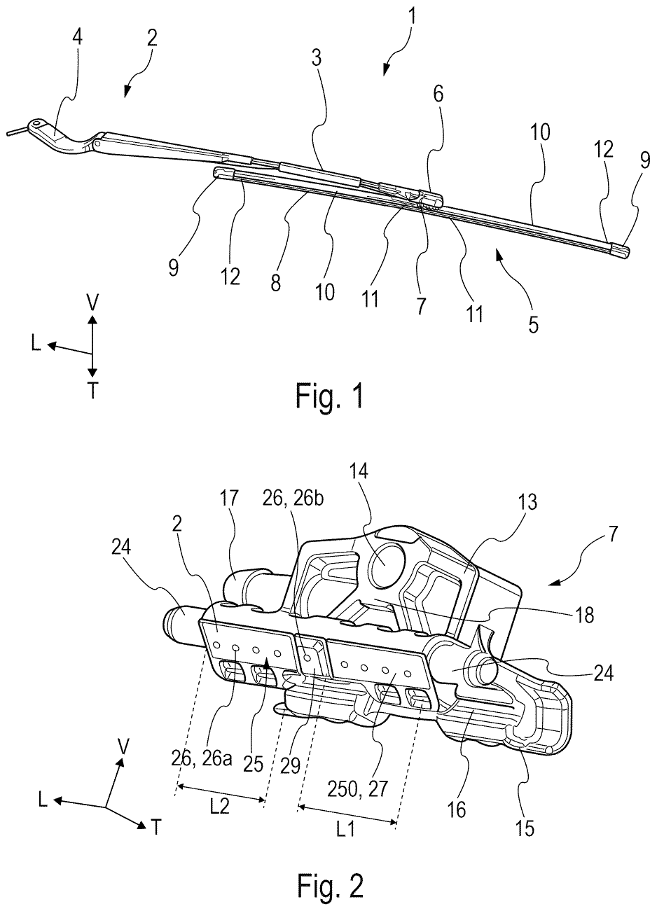

Furthermore, in the following description, reference will be made to an orientation as per the longitudinal axis L, vertical axis V and transverse axis T, as defined arbitrarily by the trihedron L, V, T shown in FIG. 1 to FIG. 7, the longitudinal direction corresponding to the main direction of elongation of the blade. The choice of designations of these axes does not limit the orientation that the device can adopt when applied to a motor vehicle.

FIG. 1 schematically illustrates a wiper system 1 for cleaning a glazed surface of a vehicle, for example a windshield, so as to improve the visibility of a driver of the vehicle, for example in rainy weather, or for the purpose of clearing the glazed surface of particles and/or dirt. The wiper system 1 comprises at least one drive arm 2 which extends between a connection end 3 and a linking end 4, opposite the connection end 3. The connection end 3 is configured to support a wiper blade 5, which extends along a longitudinal main axis of elongation, substantially parallel to the axis L. The linking end 4, opposite the connection end 3, is connected to the vehicle and more particularly to a motorized device enabling an angular back-and-forth movement of the drive arm and thus of the wiper blade. A connection system is arranged between the connection end 3 of the drive arm and the wiper blade 5 so as to be able to drive the wiper blade in the angular back-and-forth movement, this connection system comprising an adapter 6 secured to the connection end 3 and a connector 7 secured to the wiper blade 5, the adapter 6 being pivotably mounted on the connector 7.

The connector 7 of the connection system is fixed to a rigid support 19, which extends over the entire longitudinal dimension of the wiper blade 5 and which notably bears a blade rubber 8 intended to be in contact with the glazed surface.

The rigid support, or rigid blade-rubber support, 19 also bears at least one aerodynamic deflection element 10 placed longitudinally next to the connector 7. In the embodiment shown, the connector 7 is positioned between two distinct deflection elements 10, each deflection element 10 extending the connector 7 at one of the longitudinal ends of the connector 7.

Each deflection element 10 has a first end 11, referred to as proximal end in that it is linked to the connector 7, and a second end 12, referred to as distal end. The wiper blade 5 comprises, at each of its longitudinal ends, i.e. at the second end 12 of each deflection element 10, an endpiece 9 which keeps in longitudinal position the various elements of the wiper blade 5, i.e. the rigid blade-rubber support, the blade rubber 8 and the deflection element 10. The result of the above is that both the connector 7 and the endpiece 9 form an element of the wiper blade 5 that is connected to the deflection element 10.

The wiper blade has a built-in cleaning-fluid spraying and supplying system which makes it possible to spray cleaning fluid onto the glazed surface from the wiper blade and thus in targeted fashion before the blade rubber passes over the glazed surface. Advantageously, the built-in system on the wiper blade has fluid distribution and conveying ducts formed both within the connector 7 and within the deflection elements, and also spraying means, i.e. spray holes or a spray orifice distributed both on these deflection elements and on the connector.

According to the invention, and as will be set out below, the connector comprises within it a distribution node formed by the point where a conveying duct meets a distribution duct, the distribution node having an opening formed in the extension of the conveying duct and leading out of the connector, the opening being shut off by a cover in which a spray orifice is drilled.

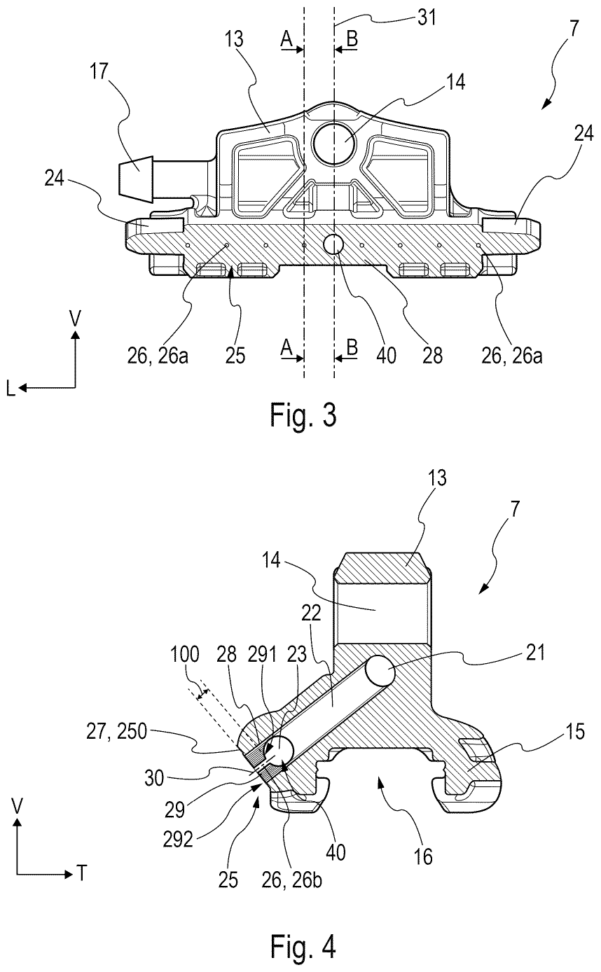

FIG. 2 and FIG. 3 illustrate an overview and a view in partial section, respectively, of the connector 7 according to one embodiment of the invention. The connector 7 extends in a longitudinal main direction of elongation, substantially parallel to the axis L.

The connector 7 notably comprises a base 15 forming a portion for fixing to the wiper blade 5 and a low wall 13 forming a vertical projection, with respect to the axis V, and configured to interact with the adapter 6 and to enable a relative rotational movement of the adapter with respect to the connector along the transverse axis T. The low wall 13 interacts with the adapter 6 notably by the insertion of a pin borne by the latter into a transverse bore 14.

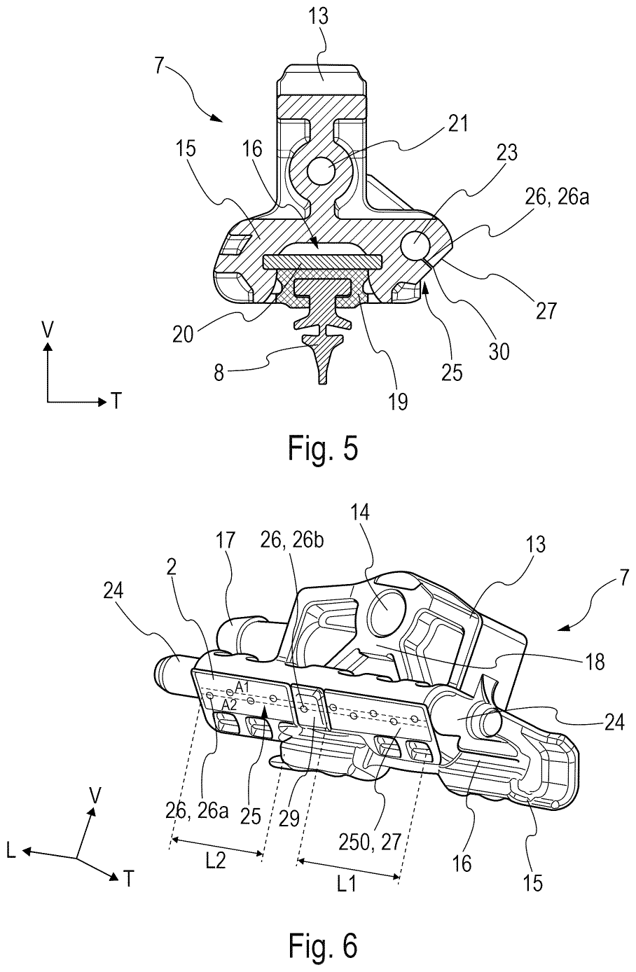

The base 15 extends all along the connector 7, parallel to the axis L, and comprises a receiving portion 16 for the wiper blade 5 and more particularly, as illustrated in more detail in FIG. 5, a receiving portion for the rigid blade-rubber support 19 intended to support the blade rubber 8. The rigid blade-rubber support 19 also forms a support for a flexible element 20, notably known by the term “stiffening spline”, which notably makes a contribution to the application of the rigid blade-rubber support 19 and the associated blade rubber 8 to the glazed surface. More particularly, the combination of the rigid blade-rubber support 19 and the flexible element 20 allows the blade rubber 8 to closely follow the shape of the glazed surface, for example a slightly curved shape, while at the same time ensuring the application of the blade rubber 8 to the glazed surface to make it possible, during the back-and-forth movements of the wiper system 1, to expel particles, water and/or dirt from the glazed surface.

The connector 7 comprises a cleaning-fluid conveying circuit defined within the connector 7. The conveying circuit extends between a fluid inlet and at least one fluid outlet and comprises at least one conveying duct and a distribution duct.

The fluid inlet is formed by a supply member 17 intended to be accommodated in a supply hose of the vehicle. More particularly, the supply hose is a flexible element which is connected at one end to a cleaning-fluid reservoir of the vehicle, and at an opposite end to the supply member 17 of the connector 7, and which can notably extend along the drive arm 2, by being clipped thereto.

In the embodiment shown in FIG. 2 and FIG. 3, which can be seen more particularly in FIG. 5, the fluid conveying circuit within the connector 7 is formed by a first conveying duct 21, a second conveying duct 22 and a distribution duct 23. The first conveying duct 21 extends substantially parallel to the axis L from the supply member 17 to a median longitudinal portion 18 of the connector 7. The cleaning fluid is pumped from the reservoir of the vehicle and flows via the supply hose to the supply member 17 and then to the first conveying duct 21.

The second conveying duct 22 extends substantially perpendicularly in relation to the first conveying duct 21, mainly through a vertical and transverse plane of elongation, so as to connect the first conveying duct 21 placed in the low wall 13 to the distribution duct 23 placed in the base 15. It will be understood that the cleaning fluid from the fluid reservoir of the vehicle enters the connector 7 via the supply member 17 and flows in the first conveying duct 21 and then in the second conveying duct 22 to the distribution duct 23.

As mentioned above, the conveying circuit extends between a fluid inlet and at least one fluid outlet. In the embodiment shown in FIG. 2, the connector 7 comprises two fluid outlets, each of these outlets being formed by a cannula 24 intended to be accommodated in a spray channel of a deflection element 10. The spray channel extends along the associated deflection element 10 and has a plurality of holes drilled in it, through which the cleaning fluid can be sprayed toward the glazed surface of the vehicle. It will be understood that the cannulae 24 each form a connection means between the connector 7 and a deflection element 10 of the wiper blade S for the flow of the cleaning fluid from the connector 7 to the spray channel of an associated deflection element 10.

The distribution duct 23 extends longitudinally from one longitudinal end of the connector 7 to the other. It should be noted that the distribution duct 23 is longitudinally defined strictly between the cannulae 24 forming the fluid outlets. In other words, the cannulae 24 forming the fluid outlets of the connector 7 do not form part of the distribution duct 23 and each cannula 24 defines within it a circulation duct distinct from the distribution duct.

It should be noted that, in the embodiment shown, the conveying circuit comprises two conveying ducts 21, 22, but it does not constitute a departure from the scope of the invention for the conveying circuit to comprise a single conveying duct or a greater number of conveying ducts provided that at least one conveying duct, in this case the second conveying duct 22, leads into the distribution duct 23 so as to form a distribution node 40, shown notably in FIG. 4. At this distribution node 40, in the extension of the conveying duct leading into the distribution duct, in this case the second conveying duct 22, an opening 28 is formed on the outside of the connector 7, notably by a drilling operation for producing said conveying duct. The opening 28 thus has a dimension, and in this case a diameter, substantially equal to the corresponding dimension of the conveying duct that it axially extends, as can be seen in FIG. 3 and FIG. 4.

According to the invention, this opening 28 is shut off by a cover 29 in order to allow most of the cleaning fluid arriving through the conveying duct to flow into the distribution duct, and this cover 29 is perforated with at least one spray orifice 26b.

FIG. 4 illustrates more particularly the spray orifice 26b provided in the cover 29. More particularly, FIG. 4 illustrates a sectional view of the connector 7 through the sectional plane B-B shown in FIG. 3, which makes it possible notably to show the integration of function at the distribution node 40, with an opening generated in the material of the connector to enable simplified production of the conveying duct by drilling, the presence of the cover 29 for shutting off the opening 28 and making it possible to channel the cleaning fluid, and the presence of the spray orifice 26b within the cover for making it possible to spray cleaning fluid at the connector.

The cover 29 is placed on the connector so as to shut off this opening 28. It should be noted that the cover has a main body accommodated in the opening and a head, protruding from the opening and lying flush with the outer face of the connector at a distribution zone which will be described below, the head forming an abutment means when the cover is being positioned in the opening. The shape and dimensions of the main body are substantially identical to the shape and dimensions of the opening 28 so as to make it possible to retain the cover in the opening by a suitable operation, for example a force fit, an adhesive bonding operation or a welding operation.

More particularly, the cover 29 has an inner surface 291, at the free end of the main body, which faces toward the distribution duct 23, and an outer surface 292, at the free end of the head, which faces toward the outside of the connector 7. The inner surface 291 of the cover 29 contributes to defining the distribution duct 23 at the distribution node, and it therefore has a concave shape which lies in the extension of the wall defining the distribution duct 23 on either side of the second conveying duct. The outer surface 292 of the cover 29 is substantially flat and it is advantageous for it to lie flush with the outer face of the connector, at said distribution zone, so as not to generate either esthetic or aerodynamic disturbances.

The spray orifice 26b is produced as a through-orifice, i.e. one which extends from the inner surface 291 of the cover to the outer surface of this cover. A portion of the cleaning fluid entering the distribution node 40 is thus able to be sprayed onto the glazed surface, thus ensuring that a portion of the glazed surface that faces the connector is wetted.

In order to ensure that only a minimal portion of the cleaning fluid passes through the spray orifice 26b, the rest being directed toward the fluid outlets of the connector via the distribution duct, and in order to ensure that a sufficient pressure, able to perform a function of cleaning the glazed surface, is generated at the outlet of the cover, the spray orifice may have a diameter which ranges between 0.05 and 0.6 mm, and preferably between 0.05 mm and 0.3 mm.

In the example illustrated, the spray orifice 26b has a spray axis 30, shown in FIG. 4, which is parallel to a main axis of elongation of the conveying duct leading into the distribution duct, in this case the second conveying duct 22, and this has an advantage for making it easier to spray the cleaning fluid through this spray orifice without a pressure drop, but it should be noted that a spray axis of the spray orifice formed in the cover with a different orientation than that illustrated would also be within the scope of the invention.

Furthermore, in the example illustrated, a single spray orifice 26b is formed substantially in the center of the cover 29, but it should be noted that multiple spray orifices could be provided in the cover without departing from the context of the invention.

The cover 29 is in this case placed longitudinally in the center of the connector 7, i.e. on a transverse midplane 31 extending along the axis T and the axis V, perpendicularly in relation to the longitudinal direction of the distribution duct 23. This transverse midplane 31 divides the connector 7 into two parts which have identical longitudinal dimensions. This arrangement, which is made possible by the central placement of the conveying duct in the extension of which the cover is placed, is notably advantageous in connectors in which only one spray orifice in accordance with what was just described, i.e. formed in the cover, is provided on the connector. This ensures a distribution of cleaning fluid, with lines placed on either side of the connector, and the connector equipped with a spray orifice in a central position, which is substantially uniform.

In a context which will be described below, with other built-in spraying means on the connector, the position of the cover and of the spray orifice formed in the cover could be offset from the transverse midplane.

The distribution duct 23 extends more particularly within at least one distribution zone 25 which contributes to forming a lateral part of the base 15 intended to face the glazed surface of the vehicle. More particularly, the at least one distribution zone 25 has an outer face 250 intended to face the glazed surface.

The cover 29 is placed in the longitudinal extension of this at least one distribution zone 25, i.e. placed next to this at least one distribution zone, so as to together form an overall distribution zone which extends from one longitudinal end of the connector to the other.

A first embodiment is more particularly described with reference to FIG. 2 to FIG. 5, with two distribution zones 25 placed one on each side of the cover 29. In other words, the cover 29 is placed between the distribution zones 25, in the longitudinal extension of each of these zones so as to form, from one longitudinal end of the connector to the other, an overall distribution zone within which the distribution duct 23 extends. As illustrated in FIG. 2, a first distribution zone extends over a first longitudinal dimension L1 from a longitudinal end of the connector to the cover 29 and a second distribution zone extends over a second longitudinal dimension L2 from a longitudinal end of the connector to the cover 29.

Each distribution zone 25 can have spray holes 26a drilled in it which emerge respectively on the outer face 250 of the connector at a distribution zone. In the embodiment illustrated, spray holes 26a are placed on either side of the cover 29 in which the spray orifice 26b is drilled. These spray holes, formed in addition to the spray orifice, increase the area covered by the spraying of cleaning fluid at the connector. In other words, in this exemplary embodiment, the connector has a plurality of spraying means 26 which lead into the distribution duct 23 and through which the cleaning fluid can be sprayed toward the glazed surface of the vehicle. More specifically, the spraying means 26 comprise the at least one spray orifice 26b provided through the cover 29 and the spray holes 26a provided on either side of the cover 29.

In the example illustrated, the outer face 250 of each distribution zone 25, intended to face the glazed surface, has a flattened portion 27, which extends from one longitudinal end of the corresponding distribution zone 25 to the other. Considering the connector outer face 250, formed by the outer face of each distribution zone, the flattened portion 27 is in this case locally interrupted by the presence of the cover 29. Each of the spray holes 26a emerges on one of the flattened portions 27. The cover 29, or more particularly the head of the cover, is placed in the opening 28 so as to lie flush with the flattened portion 27 of each distribution zone 25 and thus contribute to forming a flat surface from one longitudinal end of the connector to the other.

FIG. 5 illustrates a sectional view of the connector 7 through the sectional plane A-A shown in FIG. 3. More particularly, FIG. 5 makes it possible to illustrate a spray hole 26a provided in the at least one distribution zone 25 of the connector and leading into the distribution duct 23. The spray hole 26a illustrated in FIG. 5 comprises, advantageously and like the set of spraying means 26 of the connector 7, a spray axis 30 about which each spraying means 26 extends, from the distribution duct 23 to the flattened portion 27 in the case of the spray holes 26a, and from the distribution duct 23 to the outer surface 292 of the cover 29 in the case of the spray orifice 26b.

The spraying means 26 are produced by means of laser drilling. The use of such a manufacturing means makes it possible to form spraying means 26 that have a diameter about the spray axis 30 which ranges between 0.05 mm and 0.6 mm, preferably between 0.05 and 0.3 mm, and more preferably is equal or substantially equal to 0.2 mm. Theoretically, allowing for manufacturing tolerances, each spraying means 26 has a diameter equal to the mean diameter of the neighboring spraying means 26. The spray orifice 26b may, advantageously, be preformed when the cover 29 is being manufactured, for example during a material injection operation or during an additive manufacturing operation, or be formed, like the spray holes 26a, by a laser drilling process.

It should be noted that the diameter of the spraying means 26, and for example if it is equal to 0.2 mm, can notably be similar to the diameter of the holes provided on the deflection elements 10, and this makes it possible to spray the cleaning fluid toward the glazed surface at a similar pressure over the entire longitudinal dimension of the wiper blade 5, both at the deflection elements and at the connector.

When the outer face of the distribution zone 25 is formed by the flattened portion 27, the spray axis 30 of the spraying means 26 is substantially perpendicular to the plane of elongation of the flattened portion 27 such that the spray axis 30 of the spraying means 26 intersects the distribution duct 23, The flattened portion 27 makes it possible, advantageously, to improve the precision of the laser drilling by providing a flat surface on which to perform said drilling, in a direction perpendicular to the distribution duct 23. It will be understood that the flattened portion 27 and the outer surface 292 of the cover 29 have a similar form when the cover is accommodated in the opening 28. More specifically, and as mentioned above, the cover 29 lies flush with the flattened portion 27 such that, during the drilling process, the inclination of the surface is identical between the flattened portion 27 and the cover 29. Such a similarity makes it easier to produce the various spraying means 26.

The at least one distribution zone 25 has a thickness 100 between the distribution duct 23 and the flattened portion 27 that remains constant, i.e. that remains the same allowing for manufacturing tolerances, over a longitudinal dimension from at least one spraying means 26 to a neighboring spraying means 26. The thickness 100 of a distribution zone is measured in a direction parallel to the spray axis 30 of a spraying means 26, between an inner face 251 of the distribution zone 25 which defines the distribution duct and the outer face 250 intended to face toward the glazed surface. It can be considered, as can be seen in FIG. 4 and FIG. 5, that the value of the thickness 100 is the same at the cover or in the one or more distribution zones on either side of the cover, such that the constant thickness of the one or more distribution zones can advantageously extend from one longitudinal end of the connector to the other, so as to form a uniform overall distribution zone on the connector. In this way, each spraying means 26 is produced from an amount of material equivalent to that from which the other spraying means 26 are produced.

This constant thickness from one longitudinal end of the connector to the other, between the one or more distribution zones 25 and the cover 29, thus means it is not necessary to modify the parameters of the laser source for performing the drilling of each of the spraying means 26 throughout the distribution zone 25.

Furthermore, as shown in FIG. 3, the spray holes 26a are placed on either side of the transverse midplane 31 of the connector 7, it being understood that, in the exemplary embodiment illustrated, the spray orifice 26b formed on the cover 29 is placed in said plane 31.

Advantageously, the connector 7 comprises at least two spray holes 26a on either side of the transverse midplane 31. In the embodiment shown in FIG. 3, the connector 7 comprises four spray holes 26a placed on either side of the transverse midplane 31 of the connector 7, with in this case said plane 31 passing through the spray orifice 26b.

The distribution of the spray holes 26a is symmetrical on either side of the transverse midplane 31 of the connector 7. More particularly, the spraying means 26, i.e. both the spray holes and the spray orifice, are substantially aligned longitudinally along the connector.

The spraying means 26 are provided longitudinally at regular intervals on the connector. It will be understood that the spraying means 26 are therefore continuous from one end of the connector 7 to another, with the spray orifice 26b in the center.

And, according to one feature of the invention, considering the blade as a whole, the regular interval formed between two neighboring spraying means 26 of the connector 7 is the same or substantially the same as the interval between two neighboring holes for spraying cleaning fluid at the deflection elements. By way of example, the distance may vary from 0.28 mm to 13.7 mm. It should be noted that this distance between two neighboring spraying means 26 is measured longitudinally from the spray axis 30 of one spraying means 26 to the spray axis 30 of a neighboring spraying means 26.

The distance between two neighboring spraying means 26 can advantageously be equal to a mean value of the distances between two neighboring holes formed on a deflection element 10. In this way, from one longitudinal end of the wiper blade 5 to the other, the same spacing is maintained between two cleaning-fluid spraying elements and a uniform spraying of cleaning fluid over the entire blade is ensured.

This placement of the spraying means 26, and more particularly the associated distance, can be a function of the diameter of the spraying means 26. Specifically, as described above, the spraying means 26 have a diameter which ranges between 0.05 mm and 0.6 mm, and the distance between two neighboring spraying means 26 can increase as the diameter of the spraying means 26 increases.

By way of illustrative and nonlimiting examples, the distance between two neighboring spraying means with a diameter of 0.05 mm is 0.28 mm, the distance between two neighboring spraying means with a diameter of 0.15 mm is 2.65 mm, the distance between two neighboring spraying means with a diameter of 0.2 mm is 5 mm, and the distance between two neighboring spraying means with a diameter of 0.3 mm is 13.7 mm.

However, it should be noted that, in this first embodiment, like in the variants which will be described, it would be possible to provide, without departing from the context of the invention, that the distance between two neighboring spraying means is not the same from one longitudinal end of the contact to the other, and that the various distances can vary, linearly or not linearly.

A description will now be given of a first variant of the invention, with reference to FIG. 6, which differs from what was described above in that the spray holes formed in the distribution zones 25 extend on two levels. In other words, the spray holes are grouped into a first subassembly within which some of the spray holes are aligned on a first longitudinal axis A1 and a second subassembly within which the other spray holes are aligned on a second longitudinal axis A2.

In the example illustrated, the holes are distributed alternately in the first subassembly and in the second subassembly.

It will be understood that this variant makes it possible to direct the cleaning fluid sprayed via the connector onto different zones of the glazed surface, and thus improve the cleaning performance of the wiper system.

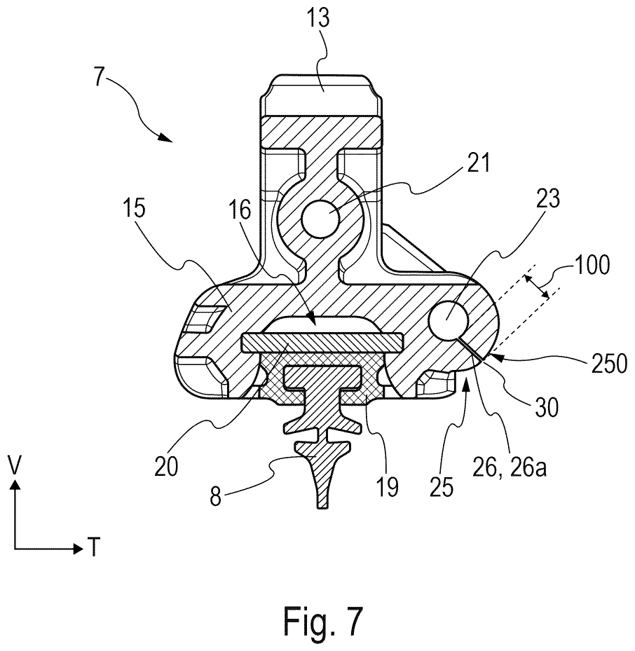

A second variant is illustrated in FIG. 7. It differs from what was described and illustrated above in that the outer face 250 of the connector at the distribution zone is in this case curved and does not have a flattened portion. The thickness 100, which as above is measured radially between the distribution duct and the outer face 250 of the distribution zone, can be continuous over the longitudinal dimension of the distribution zone.

It is apparent in the above description of the various embodiments and exemplary embodiments that the invention clearly achieves its set objective by providing a wiper blade of which the distribution of the fluid is improved notably at the connector for securing the wiper blade to a drive arm of a wiper system, by realizing at least one distribution zone within which a cover which shuts off a duct for conveying a cleaning fluid toward a distribution duct comprises a spray orifice through which the cleaning fluid can be sprayed toward the glazed surface of a vehicle.

The invention as described above is not, however, limited to the means and configurations exclusively described and illustrated, and also applies to all equivalent means or configurations and to any combination of such means or configurations

1. A connector for connecting a wiper blade of a wiper system of a vehicle to a drive arm of the wiper system, the connector comprising a cleaning-fluid conveying circuit defined within the connector and extending between a fluid inlet, configured to interact with a cleaning-fluid supply hose, and at least one fluid outlet, configured to communicate with a cleaning-fluid spray channel within the wiper blade, the cleaning-fluid conveying circuit includes at least one distribution duct extending longitudinally from one longitudinal end of the connector to the other and a conveying duct leading into the distribution duct while forming a distribution node, the at least one fluid outlet longitudinally extending the distribution duct, wherein the distribution node includes an opening which is on an outer face of the connector and is shut off by a cover, the cover includes at least one spray orifice.

2. The connector as claimed in claim 1, wherein the at least one spray orifice is advantageously provided in the cover in a direction which, when the cover is assembled with the connector, is substantially parallel to a main axis of elongation of the conveying duct.

3. The connector as claimed in claim 1, wherein the at least one spray orifice has a diameter which ranges between 0.05 and 0.6 mm.

4. The connector as claimed in claim 1, wherein the connector includes at least one distribution zone which is provided at least partially along the distribution duct and in which at least one spray hole is formed, the cover being disposed in the longitudinal extension of this at least one distribution zone.

5. The connector connector as claimed in claim 4, wherein the cover is placed so as to lie flush with the outer face of the connector in the at least one distribution zone.

6. The connector as claimed in claim 4, wherein two distribution zones are formed one on each side of the cover within which the at least one spray orifice is provided, spray holes being formed in each of the distribution zones.

7. The connector as claimed in claim 4, wherein the outer face of the at least one distribution zone is formed by a flattened portion which extends in a plane substantially perpendicular to a direction parallel to a spray axis of the spray orifice.

8. The connector as claimed in claim 4, wherein each spraying orifice or hole formed in the at least one distribution zone and the cover is spaced apart from a neighboring spraying orifice or hole by a distance that ranges between 0.2 and 20 mm.

9. The connector as claimed in claim 4, wherein at least one distribution zone has a constant thickness.

10. A wiper blade of a wiper system of a vehicle comprising at least one connector for connecting the wiper blade to a drive arm of the wiper system, the at least one connector includes a cleaning-fluid conveying circuit defined within the connector and extending between a fluid inlet, configured to interact with a cleaning-fluid supply hose, and at least one fluid outlet, configured to communicate with a cleaning-fluid spray channel within the wiper blade, the cleaning-fluid conveying circuit includes at least one distribution duct extending longitudinally from one longitudinal end of the connector to the other and a conveying duct leading into the distribution duct while forming a distribution node, the at least one fluid outlet longitudinally extending the distribution duct, wherein the distribution node includes an opening which is on an outer face of the connector and is shut off by a cover, the cover includes at least one spray orifice.
